(19) United States
(12) Patent Application Publication
(10) Pub. No.: US 2007/0165404 A1
(43) Pub. Date: Jul. 19, 2007

(54) Curing light source device

(76) Inventor: Chih-Chen Cheng, Chungli City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/331,147

(22) Filed: Jan. 13, 2006

(51) Int. Cl. F21V 33/00

(52) U.S. Cl. 362/253

(57) ABSTRACT

A curing light source device comprises a curing light source module, a drive unit and a current sensor. The curing light source module has at least a series-connected group with at least an LED for emitting light of a specific wavelength. The drive unit is used to drive the curing light source module and provide working power for the curing light source module. The current sensor is connected between the curing light source module and the drive unit, and is used to regulate the current provided by the drive unit for the curing light source module. Through the arrangement manner of the LEDs and the over-current protection function of the current sensor, these LEDs can be prevented from burning out.

### BACKGROUND OF THE INVENTION

1. Field of the Invention

The present invention relates to a curing light source device and, more particularly, to a curing light source device utilizing light emitting diodes.

2. Description of Related Art

The light emitting diode (LED) is a breakthrough in light source devices. An LED is a semiconductor light emitting component. As compared to a conventional incandescent lamp or fluorescent lamp, the LED produces a cold light, and has the advantages of high brightness, small size, power saving, long lifetime, and no discharge of harmful materials such as mercury. The LED has become one of the environmental protection light sources that are much appreciated. The color of LED light can be arbitrarily combined to make the product more popular and fashion. With the trend toward more compactness of industrial products, the demand of LED is steadily on the increase. The LED technology has already been an important market of the global optoelectronic industry.

An LED is a semiconductor light source, which converts electric energy into optical energy. With a forward voltage applied across two terminals of a semiconductor pn junction, when the current flows through the junction, electrons and holes recombine with the extra energy released in the form of photons. According to the material used, photons with different energies (wavelengths) will be produced. Light visible to human eyes has a wavelength between 400˜780 nm. Outside this range is called invisible light, including infrared (IR) and ultraviolet (UV) lights.

The LED has also been widely applied in curing light sources. A light cured polymer has to absorb light of a specific wavelength for polymerization. The LED has been used to replace conventional curing light sources. LED lights of different colors have been used to cure light cured polymer.

With the ordinary composite resin used to fill a tooth cavity as the example, its photo initiator has absorption wavelength between 410˜-500 nm. The most effective absorption wavelength is about 465 nm. In the past, a spectrum suitable for curing (blue light) of a halogen light machine is sifted out by a filter to achieve photo-thermal effect, changing chemical molecule bonds to accomplish curing of the composite resin. On the other hand, a blue LED makes use of semiconductor material and structure to efficiently produce a blue light, whose wavelength exactly conforms to the optimum absorption wavelength and is thus more suitable for curing. Moreover, the required current of a low power semiconductor device is small, effective operation only by battery energy is feasible.

In order to answer for various specific wavelengths required for various cured materials, however, various LEDs have been integrated together to make a light source having various light wavelengths. Because LEDs of different colors have different drive voltages (e.g., a 1-W blue, white or green LED has a drive voltage of about 3.5˜4 V, but a red LED has a drive voltage of about 2.5 V), burnout due to overcurrent may easily occur or the light emission efficiency is not satisfactory if various LEDs of different colors are driven by the same drive power source. In the prior art, LEDs of each color are driven by a drive circuit. But the same number of drive circuits are required as the number of light colors of LEDs, hence increasing the complexity of circuit. Accordingly, the protection measures for LEDs of various colors in a curing light source device has to be improved.

### SUMMARY OF THE INVENTION

An object of the present invention is to provide a curing light source device, which makes use of current regulation and/or arrangement manner of LEDs to avoid the situation of burnout without the need of several drive circuits, thereby enhancing the usage efficiency and lifetime of the curing light source device.

To achieve the above object, the present invention provides a curing light source device comprising a curing light source module and a drive unit. The curing light source module has at least a series-connected group with at least an LED for emitting light of a specific wavelength. The drive unit is used to drive the curing light source module and provide working power for the curing light source module. Through the arrangement manner of the LEDs, the voltage difference between the series-connected groups becomes smaller. After the series-connected groups are parallel connected together and then connected to a working power source, the currents flowing through each series-connected group will be more equal, hence enhancing the reliability.

To achieve the above object, the present invention also provides a curing light source device comprising a curing light source module, a drive unit and a current sensor. The curing light source module has at least a series-connected group with at least an LED for emitting light of a specific wavelength. The drive unit is used to drive the curing light source module and provide working power for the curing light source module. The current sensor is connected between the curing light source module and the drive unit and used to regulate the current provided by the drive unit to the curing light source module. Through the arrangement manner of the LEDs and the overcurrent protection of the current sensor, the LEDs can be prevented from burning out.

### BRIEF DESCRIPTION OF THE DRAWINGS

The various objects and advantages of the present invention will be more readily understood from the following detailed description when read in conjunction with the appended drawing, in which:

FIG. 1 is a block diagram according to a first preferred embodiment of the present invention;

FIG. 2 is a circuit connection diagram between components according to the first preferred embodiment of the present invention;

FIG. 3 is a component block diagram according to a first preferred embodiment of the present invention; and

FIG. 4 is a circuit diagram showing how LEDs are arranged in a curing light source module according to a preferred embodiment of the present invention.

### DETAILED DESCRIPTION OF THE PREFERRED EMBODIMENTS

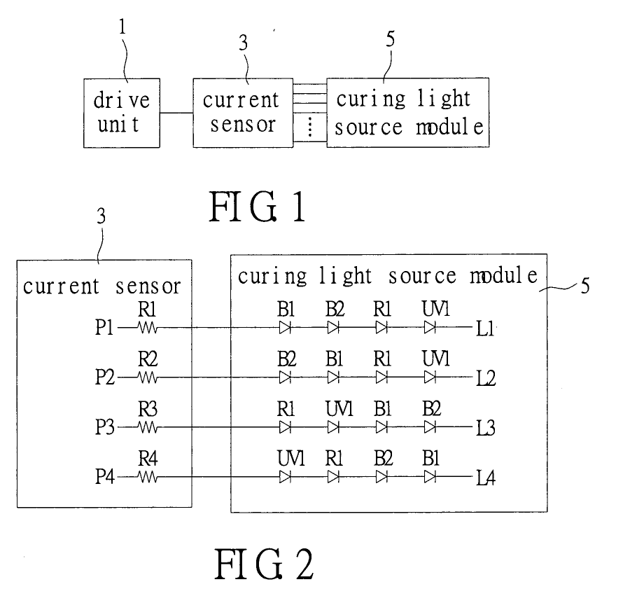

As shown in FIG. 1, a curing light source device of the present invention comprises a drive unit 1, a current sensor 3 and a curing light source module 5. The drive unit 1 drives the curing light source module 5 via the current sensor 3, and provides working power for the curing light source module 5. The curing light source module 5 has at least a series-connected group with at least an LED (not shown) for emitting a specific wavelength. Within the working voltage range, a plurality of LEDs is disposed in the series-connected group. From the statistics theory, the variance of the total drive voltage of each series-connected group is about 1/(n)^{1/2} of the sum of the variance of the drive voltage of each LED, where n is the number of series-connected LEDs. Therefore, the voltage difference between different series-connected group becomes smaller. After the series-connected groups are parallel connected together and then connected to a working power source, the currents flowing through each series-connected group will be more equal, hence enhancing the reliability.

The LED can be a blue LED, a UV LED or a red LED. The drive unit 1 comprises a power supply device (not shown). The power supply device is a single power supply device, which can be a battery or an energy storage component for providing working power for the curing light source module 5. The drive unit 1 is respectively connected to the current sensor 3 and each connected-connected group in the curing light source module 5 via a plurality of circuits. The current sensor 3 is used to regulate the current provided to the curing light source module 5 to prevent the LEDs in the curing light source module 5 from burning out.

FIG. 2 is a circuit connection diagram between components according to the first preferred embodiment of the present invention. The current sensor 3 has four protection circuits P1, P2, P3 and P4, which include resistance components R1, R2, R3 and R3, respectively. The resistance components R1, R2, R3 and R4 have positive temperature coefficients. The curing light source module 5 has four series-connected groups L1, L2, L3 and L4, each having four series-connected LEDs: two blue LEDs B1 and B2, a red LED R1 and a UV LED UV1. The four series-connected groups L1, L2, L3 and L4 in the curing light source module 5 are connected to the four protection circuits P1, P2, P3 and P4 in the current sensor 3, respectively. If the red LED R1 in the series-connected group L1 in the curing light source module 5 is damaged to cause a too large current flowing through the positive temperature coefficient resistance component R1, the temperature of the resistance component R1 will rise. Because of the positive temperature coefficient characteristic of the resistance component R1, the resistance of the resistance component R1 will increase to regulate the current flowing through and thus protect the two blue LEDs B1 and B2 and the UV LED UV1 from burning out. Other series-connected groups L2, L3 and L4 can similarly protect the LEDs B1, B2, R1 and UV1 in the protection circuits P2, P3 and P4, respectively. Therefore, the present invention utilizes the drive unit 1 to drive the curing light source module 5 and the current sensor 3 to regulate the current provided to the curing light source module 5 so as to accomplish the effect of protecting the LEDs B1, B2, R1 and UV1 in each series-connected groups L1, L2, L3 and L4.

In the present invention, the number of the series-connected groups is not limited to four. One can dispose an arbitrary number of series-connected groups according to practical circuit requirement. Moreover, the kind and number of LEDs in the series-connected group are not limited to those stated above. One can dispose any kind and number of LEDs in the series-connected group according to practical requirement. Although different kinds of LEDs have different drive voltages, the total drive voltages of the series-connected groups that are series connected in this way will be approximately equal. Therefore, the usage rate of the working power can be close to 100%. The curing light source module 5 designed in this way is more suitably driven by battery. If there are two or more series-connected groups in the curing light source module 5, the total number of LEDs of each series-connected group is the same, and the number of same-kind LEDs is also the same.

For instance, three blue LEDs, two red LEDs and two UV LEDs are disposed in each of the series-connected groups L1, L2, L3 and L4; or three blue LEDs and a red LED are disposed in each of the series-connected groups L1, L2, L3 and L4; or four blue LEDs and two UV LEDs are disposed in each of the series-connected groups L1, L2, L3 and L4. The combination of kind and number of LEDs should be within the allowable drive range of the drive unit 1.

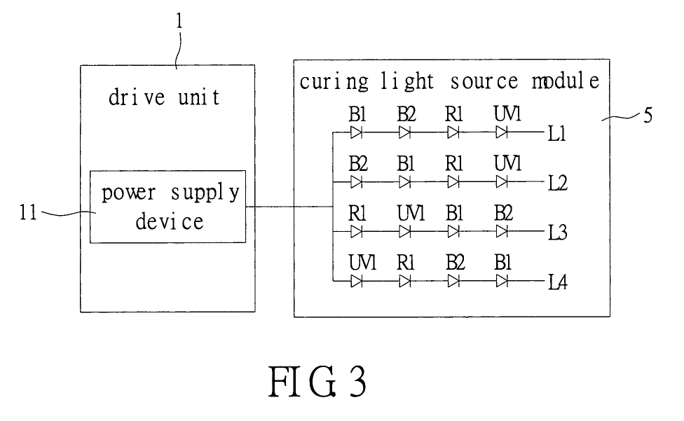

As shown in FIG. 3, a curing light source device of the present invention comprises a drive unit 1 and a curing light source module 5. The drive unit 1 directly drives the curing light source module 5, and provides working power for the curing light source module 5. The curing light source module 5 has at least a series-connected group with at least an LED for emitting a specific wavelength. Within the working voltage range, a plurality of LEDs is disposed in the series-connected group. From the statistics theory, the variance of the total drive voltage of each series-connected group is about 1/(n)^{1/2} of the sum of the variance of the drive voltage of each LED, where n is the number of series-connected LEDs. Therefore, the voltage difference between different series-connected group becomes smaller. After the series-connected groups are parallel connected together and then connected to a working power source, the currents flowing through each series-connected group will be more equal, hence enhancing the reliability.

The LED can be a blue LED, a UV LED or a red LED. The drive unit 1 comprises a power supply device 11. The power supply device 11 is a single power supply device, which can be a battery or an energy storage component for providing working power for the curing light source module 5.

The curing light source module 5 has four series-connected groups L1, L2, L3 and L4, each having four series-connected LEDs: two blue LEDs B1 and B2, a red LED R1 and a UV LED UV1. The four series-connected groups L1, L2, L3 and L4 in the curing light source module 5 are parallel connected together and then series connected to the power supply device 11 in the drive unit 1.

In the present invention, the number of the series-connected groups is not limited to four. One can dispose an arbitrary number of series-connected groups according to practical circuit requirement. Moreover, the kind and number of LEDs in the series-connected group are not limited to those stated above. One can dispose any kind and number of LEDs in the series-connected group according to practical requirement. Although different kinds of LEDs have different drive voltages, the total drive voltages of the series-connected groups that are series connected in this way will be approximately equal. Therefore, the usage rate of the working power can be close to 100%. The curing light source module 5 designed in this way is more suitably driven by battery. If there are two or more series-connected groups in the curing light source module 5, the total number of LEDs of each series-connected group is the same, and the number of same-kind LEDs is also the same.

For instance, three blue LEDs, two red LEDs and two UV LEDs are disposed in each of the series-connected groups L1, L2, L3 and L4; or three blue LEDs and a red LED are disposed in each of the series-connected groups L1, L2, L3 and L4; or four blue LEDs and two UV LEDs are disposed in each of the series-connected groups L1, L2, L3 and L4. The combination of kind and number of LEDs should be within the allowable drive range of the drive unit 1.

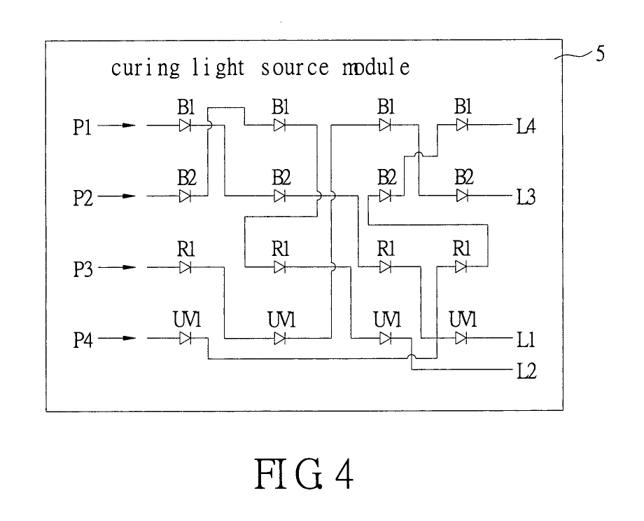

FIG. 4 is a circuit diagram showing how LEDs are arranged in a curing light source module according to a preferred embodiment of the present invention. The curing light source module 5 arranges LEDs of the same kind in the same row or in two rows. In other words, LEDs emitting light of the same kind (or the same wavelength) are arranged in the same region instead of being arranged in a staggered manner as shown in FIG. 2. With the same number and kind of LEDs in each series-connected group as stated above, the circuits of the series-connected groups L1, L2, L3 and L4 are designed to respectively connect the protection circuits P1, P2, P3 and P4 to accomplish the effect of protecting the LEDs B1, B2, R1 and UV1. In this embodiment, the number of the series-connected groups in the curing light source module 5 and the number of the protection circuits are not limited, and the kind and number of LEDs in the series-connected group are also not limited. One can dispose an arbitrary number of series-connected groups and any number and kind of LEDs according to practical requirement. Moreover, the total number of LEDs of each series-connected group in the curing light source module 5 is the same, and the number of same-kind LEDs is also the same.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

What is claimed is:

1. A curing light source device comprising:
a curing light source module having at least a series-connected group with at least an LED for emitting light of a specific wavelength; and
a drive unit used to drive said curing light source module and provide working power for said curing light source module.

2. The curing light source device as claimed in claim 1, wherein said LED includes a blue LED for emitting light of a specific wavelength.

3. The curing light source device as claimed in claim 1, wherein said LED includes a UV LED for emitting light of a specific wavelength.

4. The curing light source device as claimed in claim 1, wherein said LED includes a red LED for emitting light of a specific wavelength.

5. The curing light source device as claimed in claim 1, wherein if there are a plurality of series-connected groups, the number of said LEDs connected between said series-connected groups is the same.

6. The curing light source device as claimed in claim 1, wherein if there are a plurality of series-connected groups, the number of said LEDs of the same type connected between said series-connected groups is the same.

7. The curing light source device as claimed in claim 1, wherein if there are a plurality of series-connected groups, said series-connected groups are parallel connected together.

8. The curing light source device as claimed in claim 1, wherein said drive unit is a single power supply device.

9. The curing light source device as claimed in claim 8, wherein said single power supply device is a battery.

10. The curing light source device as claimed in claim 1, wherein said device is applied in dental surgery to cure and polymerize a composite resin.

11. A curing light source device comprising:
a curing light source module having at least a series-connected group with at least an LED for emitting light of a specific wavelength;
a drive unit used to drive said curing light source module and provide working power for said curing light source module; and
a current sensor connected between said curing light source module and said drive unit and used to regulate a current provided by said drive unit to said curing light source module.

12. The curing light source device as claimed in claim 11, wherein said LED includes a blue LED for emitting light of a specific wavelength.

13. The curing light source device as claimed in claim 11, wherein said LED includes a UV LED for emitting light of a specific wavelength.

14. The curing light source device as claimed in claim 11, wherein said LED includes a red LED for emitting light of a specific wavelength.

15. The curing light source device as claimed in claim 11, wherein if there are a plurality of series-connected groups, the number of said LEDs connected between said series-connected groups is the same.

16. The curing light source device as claimed in claim 11, wherein if there are a plurality of series-connected groups, the number of said LEDs of the same type connected between said series-connected groups is the same.

17. The curing light source device as claimed in claim 11, wherein if there are a plurality of series-connected groups, said series-connected groups are parallel connected together.

18. The curing light source device as claimed in claim 11, wherein said current sensor comprises at least a protection circuit connected to said series-connected group of said curing light source module.

19. The curing light source device as claimed in claim 18, wherein said protection circuit comprises a resistance component.

20. The curing light source device as claimed in claim 18, wherein said protection circuit comprises a positive temperature coefficient resistance component.

21. The curing light source device as claimed in claim 11, wherein said drive unit is a single power supply device.

22. The curing light source device as claimed in claim 21, wherein said single power supply device is a battery.

23. The curing light source device as claimed in claim 21, wherein said single power supply device is an energy storage component.

24. The curing light source device as claimed in claim 11, wherein said device is applied in dental surgery to cure and polymerize a composite resin.
